(19) United States
(12) Patent Application Publication
(10) Pub. No.: US 2013/0270159 A1
(43) Pub. Date: Oct. 17, 2013

(54) EXPANDABLE MODULAR ULTRA PURE WATER MACHINE

(71) Applicant: Ying-Chen Lin, Hsinchu (TW)

(72) Inventor: Ying-Chen Lin, Hsinchu (TW)

(21) Appl. No.: 13/913,514

(22) Filed: Jun. 10, 2013

Related U.S. Application Data
(63) Continuation-in-part of application No. 12/822,177, filed on Jun. 23, 2010, now Pat. No. 8,486,265.
Application No. 12/822,177 is a continuation-in-part of application No. 13/221,054, filed on Aug. 30, 2011.

(30) Foreign Application Priority Data
Sep. 2, 2010 (CN) 201020515319.5

(51) Int. Cl. C02F 9/00

(52) U.S. Cl. CPC C02F 9/00
USPC 210/85; 210/240

(57) ABSTRACT

An expandable modular ultra pure water machine has a shell, a water manifold integration device, a control module, at least one water tank and multiple water treating modules. The water manifold integration device, the control module and the water treating modules are mounted in the shell. The control module actuates the machine and controls the water flow in the water manifold integration device. The water treating modules are connected to the water manifold integration device via connectors so that the amount of them are variable to perform different functions.

### CROSS-REFERENCE TO RELATED APPLICATIONS

This application is a continuation in part application of U.S. patent application filed on Jun. 23, 2010 and having application Ser. No. 12/822,177 and of United States patent application filed on Aug. 30, 2011 and having application Ser. No. 13/221,054, the entire contents of which are hereby incorporated herein by reference.

### BACKGROUND OF THE INVENTION

1. Field of the Invention

The present invention relates to an ultra pure water machine, especially to an expandable modular ultra pure water machine

2. Description of the Prior Arts

Ultra pure water machines are widely used, especially in laboratories. Since water is required to be highly pure in laboratory work, for precision research projects and the ultra pure water machines can purify tap water into ultra pure water directly for research use. A conventional ultra pure water machine has a main body connected securely to a water tank. The main body contains multiple purifying elements therein such as pre-filters, booster pumps, reverse osmosis (RO) membranes, purification columns, ultraviolet (UV) lamps, ultra filtration (UF) membranes and solenoid valves.

However, all the purifying elements are installed securely in the main body and no space is reserved in the main body to exchange purifying elements for different uses so a new ultra pure water machine with different purification effects must be purchased. Besides, when one of the purifying elements is damaged and requires repair, workers must take apart the whole main body first, which is awkward and time wasting.

To overcome the shortcomings, the present invention provides an expandable modular ultra pure water machine to mitigate or obviate the aforementioned problems.

### SUMMARY OF THE INVENTION

The main objective of the present invention is to provide an expandable modular ultra pure water machine The expandable modular ultra pure water machine has a shell, a water manifold integration device, a control module, at least one water tank and multiple water treating modules. The water manifold integration device, the control module and the water treating modules are mounted in the shell. The control module actuates the machine and controls the water flow in the water manifold integration device. The water treating modules are connected to the water manifold integration device via connectors so that the amount of them are variable to perform different functions. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an expandable modular ultra pure water machine in accordance with the present invention;

FIG. 2 is an exploded perspective view of the expandable modular ultra pure water machine in FIG. 1;

FIG. 3 is another exploded perspective view of the expandable modular ultra pure water machine in FIG. 1;

FIG. 4 is a partial enlarged side cross-sectional view of the expandable modular ultra pure water machine in FIG. 1; and

FIG. 5 is a perspective view of the expandable modular ultra pure water machine in FIG. 1, shown the water tank mounted outside.

### DETAILED DESCRIPTION OF THE PREFERRED EMBODIMENTS

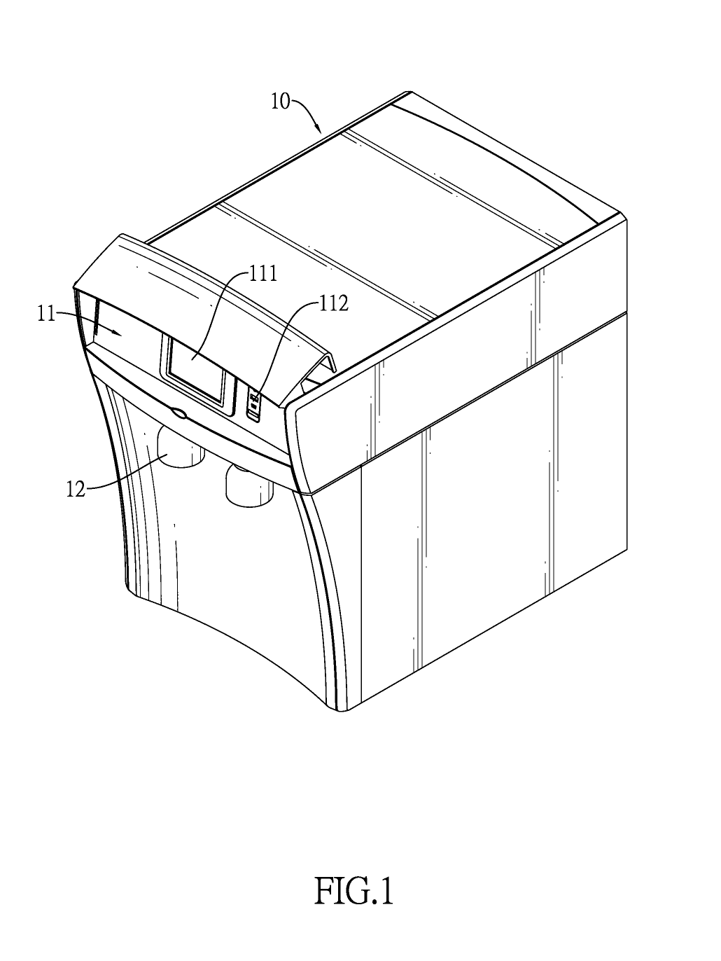

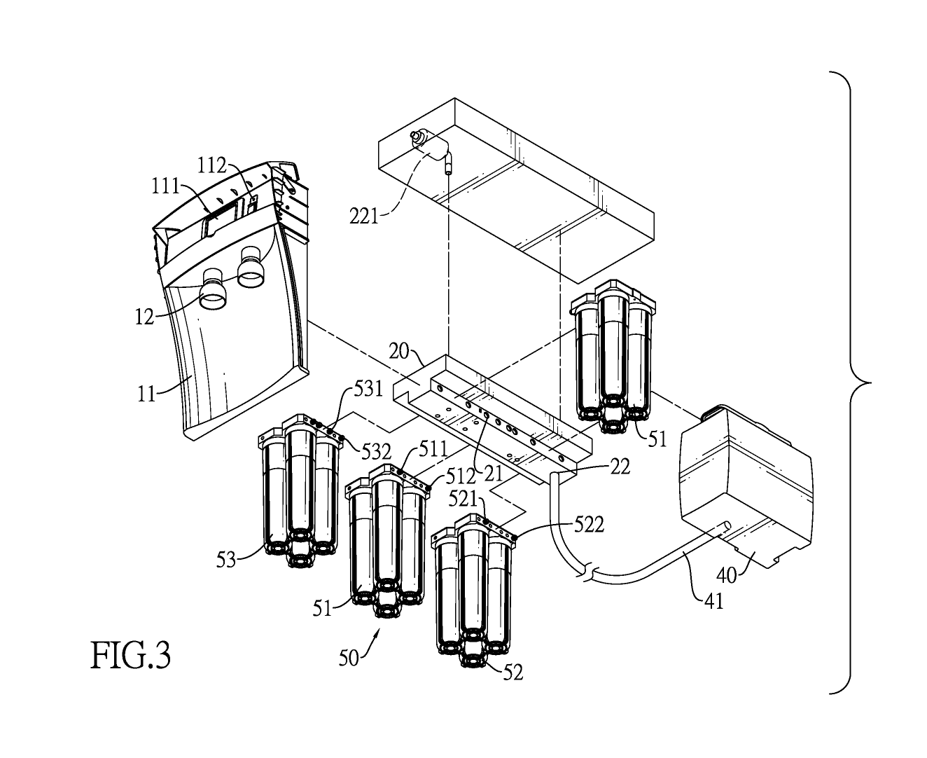

With reference to FIGS. 1 to 3, an expandable modular ultra pure water machine in accordance with the present invention comprises a shell 10, a water manifold integration device 20, a control module 30, at least one water tank 40 and multiple water treating modules 50.

The shell is hollow and has a front board 11 and at least one outlet tube 12. The front board 11 is formed in a front surface of the shell 10 and has at least one control panel 111 and at least one indicator 112 formed thereon. The control panel 111 may be a touch panel for the user to input instruction and for the machine to output information. The outlet tube 12 is mounted through and protrudes out of the front board 11.

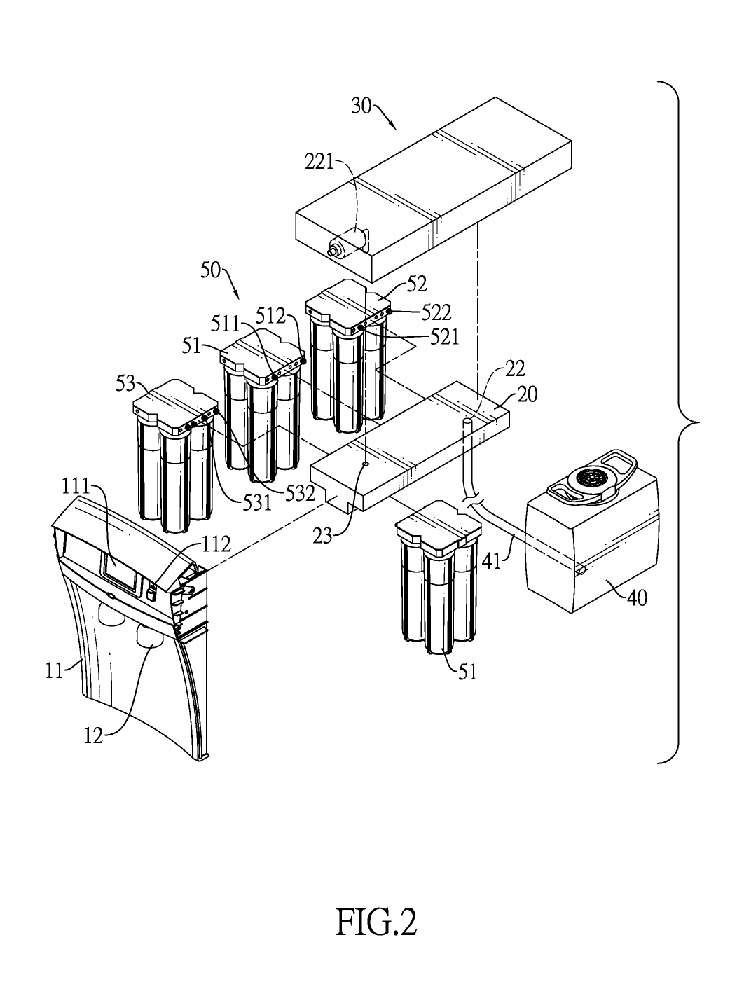

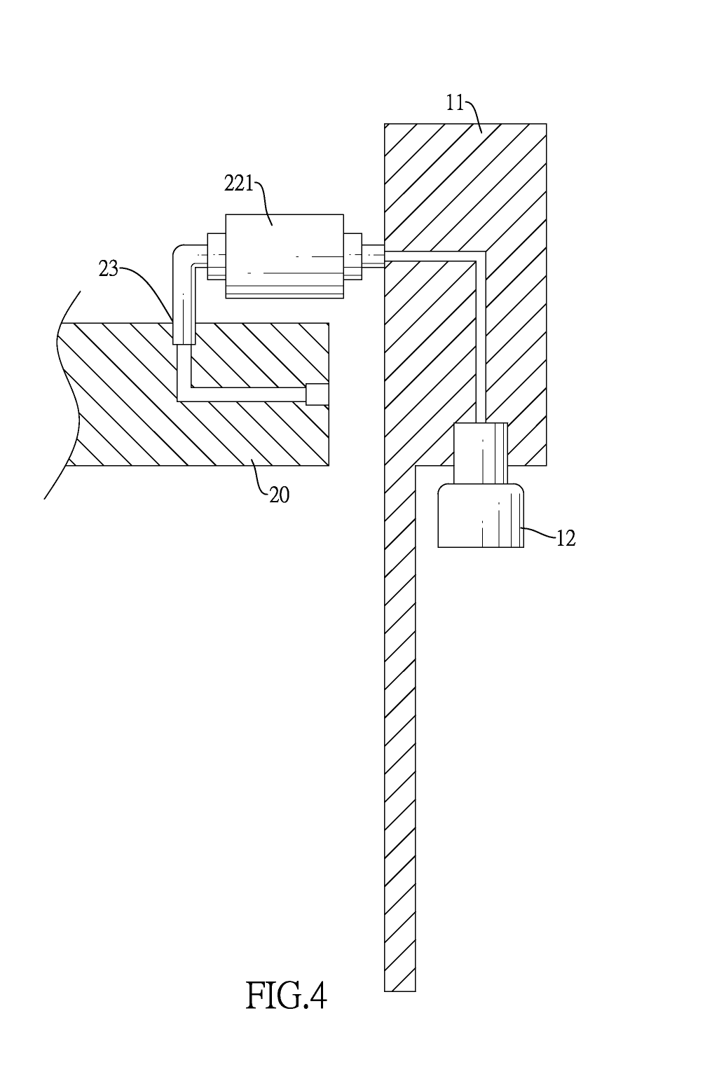

With reference to FIGS. 2 to 4, the water manifold integration device 20 with multiple water pathways and multiple solenoid valves formed inside is mounted in the shell 10, connects to the outlet tube 12 and has multiple connectors 21, a collecting connector 22 and a water outlet 23. The connectors 21 are formed separately through a sidewall of the water manifold integration device 20 and respectively connect to at least one of the water pathways. The collecting connector 22 is formed through a bottom sidewall of the water manifold integration device 20 and connects to at least one of the water pathways. The water outlet 23 is formed through a top sidewall of the water manifold integration device 20, connects to at least one of the water pathways and connects to the outlet tube 12 through an intake valve 221.

The control module 30 is mounted in the shell 10, electrically connects to the front board 11 and the solenoid valves in the water manifold integration device 20. The intake valve 221 may be mounted in the control module 30.

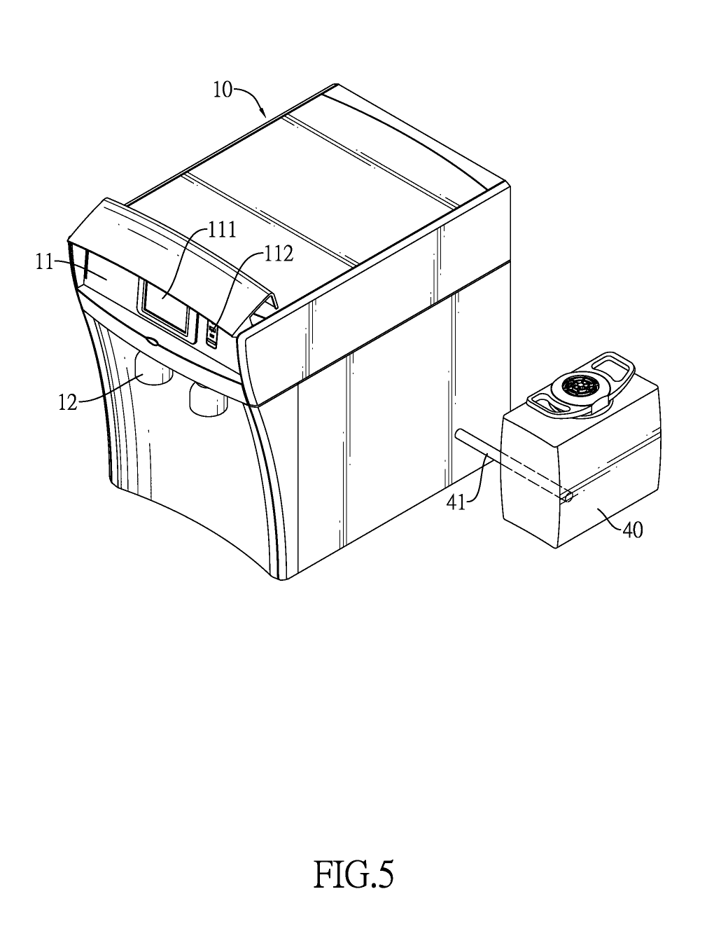

The water tank 40 connects to the water manifold integration device 20 and has a connecting tube 41. The connecting tube 41 connects to the collecting connector 22 of the water manifold integration device 20. The water tank 40 may be mounted in the shell 10, or may be mounted outside of the shell 10 as shown in FIG. 5.

The water treating modules 50 are mounted in the shell 10 and respectively connect to the water manifold integration device 20. The water treating modules 50 may include at least one purifying module 51, at least one pretreatment module 52, at least one reverse osmosis (RO) module 53. Each module 51, 52, 53 has at least one inlet connector 511, 521, 531 and at least one outlet connector 512, 522, 532 respectively connecting to corresponding connectors 21 of the water manifold integration device 20.

When the expandable modular ultra pure water machine as described operates, the control module 30 is actuated. The control panel 111 and the indicator 112 on the front board 11 may show the information of the water such as temperature, treating status and so on. The control panel 111 may be used to actuate the control module 30, to change the treating status and so on. The control module 30 actuates the solenoid valves in the water manifold integration device 20 to control the water input and water output of the water manifold integration device 20 through the water pathways, the connectors 21, the collecting connector 22 and the water outlet 23. The water is inputted into the water manifold integration device 20 through the corresponding connector 21. Then the water is outputted to the water treating modules 50 through the corresponding connectors 21 to be treated. For example, the water flows through the pretreatment module 52 to remove impurities by the fiber filters and the activated carbon filters, through the RO module 53 to leach bacteria, viruses, inorganic salts, pesticides or carcinogens, and through the purifying module 51 to exchange anions and cations by precision purification columns. Finally, the ultra pure water is produced and is outputted via the connector 21 of the water manifold integration device 20 to the water tank 40 to be collected. When the user actuates the control unit 30 to output the water, the water flows from the water tank 40 through the water pathways and the water outlet 23 of the water manifold integration device 20 and out of the outlet tube 12.

Since the water treating modules 50 are connected to the water manifold integration device 20 through the connectors 21, the amount of the water treating modules 50 are changeable to allow the manufacturer or the user to adjust the functions that are provided by the expandable modular ultra pure water machine as described.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An expandable modular ultra pure water machine comprising:
a hollow shell having
a front board formed in a front surface of the shell; and
at least one outlet tube mounted through and protruding out of the front board;
a water manifold integration device with multiple water pathways and multiple solenoid valves formed inside mounted in the shell, connecting to the outlet tube and having
multiple connectors formed separately through a sidewall of the water manifold integration device and respectively connecting to at least one of the water pathways;
a collecting connector formed through a sidewall the water manifold integration device; and
a water outlet formed through a sidewall of the water manifold integration device, connecting to at least one of the water pathways and connecting to the outlet tube;
a control module mounted in the shell, and electrically connecting to the front board and the solenoid valves in the water manifold integration device;
at least one water tank connecting to the water manifold integration device and having a connecting tube connecting to the collecting connector of the water manifold integration device; and
multiple water treating module mounted in the shell and respectively connecting to the water manifold integration device, and each module having at least one inlet connector and at least one outlet connector respectively connecting to corresponding connectors of the water manifold integration device.

2. The expandable modular ultra pure water machine as claimed in claim 1, wherein the water treating modules include at least one purifying module.

3. The expandable modular ultra pure water machine as claimed in claim 1, wherein the water treating modules include at least one pretreatment module.

4. The expandable modular ultra pure water machine as claimed in claim 2, wherein the water treating modules include at least one pretreatment module.

5. The expandable modular ultra pure water machine as claimed in claim 1, wherein the water treating modules include at least one RO module.

6. The expandable modular ultra pure water machine as claimed in claim 2, wherein the water treating modules include at least one RO module.

7. The expandable modular ultra pure water machine as claimed in claim 3, wherein the water treating modules include at least one RO module.

8. The expandable modular ultra pure water machine as claimed in claim 4, wherein the water treating modules include at least one RO module.

9. The expandable modular ultra pure water machine as claimed in claim 1, wherein the front board has at least one control panel and at least one indicator formed thereon.

10. The expandable modular ultra pure water machine as claimed in claim 1, wherein the collecting connector is formed through a bottom sidewall of the water manifold integration device.

11. The expandable modular ultra pure water machine as claimed in claim 1 further comprising an intake valve mounted in the control module and mounted between the outlet tube and the water outlet of the water manifold integration device.

12. The expandable modular ultra pure water machine as claimed in claim 1, wherein the water tank is mounted in the shell.

13. The expandable modular ultra pure water machine as claimed in claim 1, wherein the water tank is mounted outside of the shell.
